(19) United States
(12) Patent Application Publication
(10) Pub. No.: US 2010/0138603 A1
(43) Pub. Date: Jun. 3, 2010

(54) System and method for preventing data corruption after power failure

(76) Inventor: Atul Mukker, Suwanee, GA (US)

Correspondence Address: LSI Corporation c/o Suiter Swantz pc llo, 14301 FNB Parkway, Suite 220, Omaha, NE, 68154, US

(21) Appl. No.: 12/315,399

(22) Filed: Dec. 3, 2008

(51) Int. Cl. G06F 12/00

(52) U.S. Cl. 711/114; 711/E12.001

(57) ABSTRACT

A system and method for preventing data corruption after power failure is described. The system may include a host server, a disk array, a journaling disk, and/or a RAID controller. A method for preventing data corruption after power failure may include receiving at least one of a read command or a write command, storing information on an array of disk drives at least partially based on receiving the at least one of a read command or a write command, and storing persistent information on a journaling drive.

### TECHNICAL FIELD

The present invention is related data storage and more particularly to systems and methods for storing data using a RAID configuration.

### BACKGROUND

Balancing cost and performance benefits in data storage remains a large concern for computer users. One example of a data storage system may include a Redundant Array of Inexpensive Disk (RAID) system. Some RAID configurations provide data protection with varying degrees of risk and cost. Additionally, RAID configurations may occur in different levels with each different level giving different trade-offs including protection against data loss, speed, and capacity. RAID 5, for example, may provide resiliency from drive failure by performing parity generation for WRITE operations. This parity may be stored on a different area of a RAID disk separate from a WRITE operation area. When a disk fails in the RAID 5 configuration, the READ from the missing drive may be generated from the data on other RAID drives.

### SUMMARY

The present technology is related to an apparatus for storage of data in a RAID system.

A system and method for preventing data corruption after power failure is described. The system may include a host server, a disk array, a journaling disk, and/or a RAID controller. A method for preventing data corruption after power failure may include receiving at least one of a read command or a write command, storing information on an array of disk drives at least partially based on receiving the at least one of a read command or a write command, and storing persistent information on a journaling drive.

It is to be understood that both the foregoing generat description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIG. 1 illustrates an exemplary environment in which one or more technologies may be implemented;

FIG. 2 illustrates an exemplary disk array;

FIG. 3 illustrates an exemplary disk array;

FIG. 4 illustrates an exemplary environment in which one or more technologies may be implemented.

FIG. 5 illustrates an operational flow representing example operations related to preventing data corruption after a power failure; and

FIG. 6 illustrates an alternative embodiment of the operational flow of FIG. 5

FIG. 7 illustrates an alternative embodiment of the operational flow of FIG. 5.

### DETAILED DESCRIPTION OF THE INVENTION

Reference will now be made in detail to the subject matter disclosed, which is illustrated in the accompanying drawings.

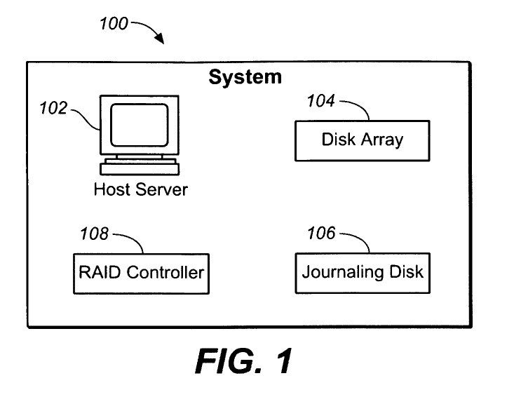

Referring generally to FIGS. 1-6, a system and method for preventing data corruption after power failure is described. System 100, illustrated in FIG. 1, may include a host server 102, a disk array 104, a journaling disk 106, and/or a RAID controller 108. A method for preventing data corruption after power failure may include receiving at least one of a read command or a write command, storing information on an array of disk drives at Least partially based on receiving the at least one of a read command or a write command, and storing persistent information on a journaling drive.

System 100 may include a disk array 104. A disk array 104 may include at least two disk drives 110. A disk drive may include a peripheral computer storage device upon which data may be stored. Some examples of a disk drive may include, for example, a hard disk, a floppy disk, and/or an optical disk. Additionally, a disk drive may include a solid state drive. For example, a disk array 104 may include a Redundant Array of Independent Disks (RAID) with multiple hard disk drives. A RAID configuration may include two or more disk drives to achieve better performance, reliability, and/or larger data volume sizes. Further, a RAID system may include a system with the ability to divide and/or replicate data among multiple hard disk drives. Data may be written on disk drives in the RAID such that failure of one of the disk drives will not result in the loss of data. Generally, a failed disk drive may be replaced and reconstructed with data from other disk drives in the array, often while the system is operating.

A RAID system may include different combinations of disk drives with different trade-offs of protection against speed, capacity, and/or data loss. Different combinations of disk drives in a RAID system may include mirroring, striping, and/or error correction. Mirroring may include the replication of a disk volume to more than one disk drive 110. Striping may include segmenting logically sequential data for assigning the data to multiple physical devices, such as separate disk drives 110. Error correction may include the ability to detect errors caused from, for example, a read and/or write operation. One example of error correction may include utilizing a parity bit. A parity bit may include a bit added to ensure the number of bits with a value of one in a given set of bits is always even or odd.

One example of a disk array 104 may include a RAID 5. A RAID 5 may utilize block-level striping with parity data distributed among each of the minimum of three disk drives 110. Some other examples of a disk array 104 may include RAID 3, RAID 4, and/or RAID 6. A RAID 3 system may include utilizing byte-level striping with a dedicated parity disk. A RAID 4 system may include utilizing block-level striping with a dedicated parity disk. A RAID 6 system may include block-level striping with two parity blocks distributed across all the disk drives 110.

System 100 may include a journaling disk 106. A journaling disk 106 may include a disk drive in addition to the disk array 104. The journaling disk 106 may be configured to store metadata while servicing a host WRITE command in a degraded RAID configuration. The volume size of the journating disk 106 may be much smaller than the size of the disk drives 110 included in the RAID configuration. The volume size of the journaling disk 106 may be smaller because the ratio of outstanding WRITE commands versus the size of a RAID volume may be very small. Additionally, a journaling disk 106 may include a flash memory-based disk drive. A flash memory-based disk drive may be advantageous because only 1 flash memory disk drive may be required to create resiliency irrespective of number of disks in a traditional RAID configuration. In one embodiment, a RAID system may include multiple hard disk drives having one terabyte of storage and a journaling hard disk drive with ten gigabytes of storage.

System 100 may include a RAID controller 108. A RAID controller 108 may include a disk array controller, which may manage the physical disk drives 110 in a disk array. A disk array controller may present the disk drives 110 to a host server 102, or host computer, as logical units. A host server 102 may include a host computer. The host server 102 may interface with the RAID controller 108 and/or a disk array 104.

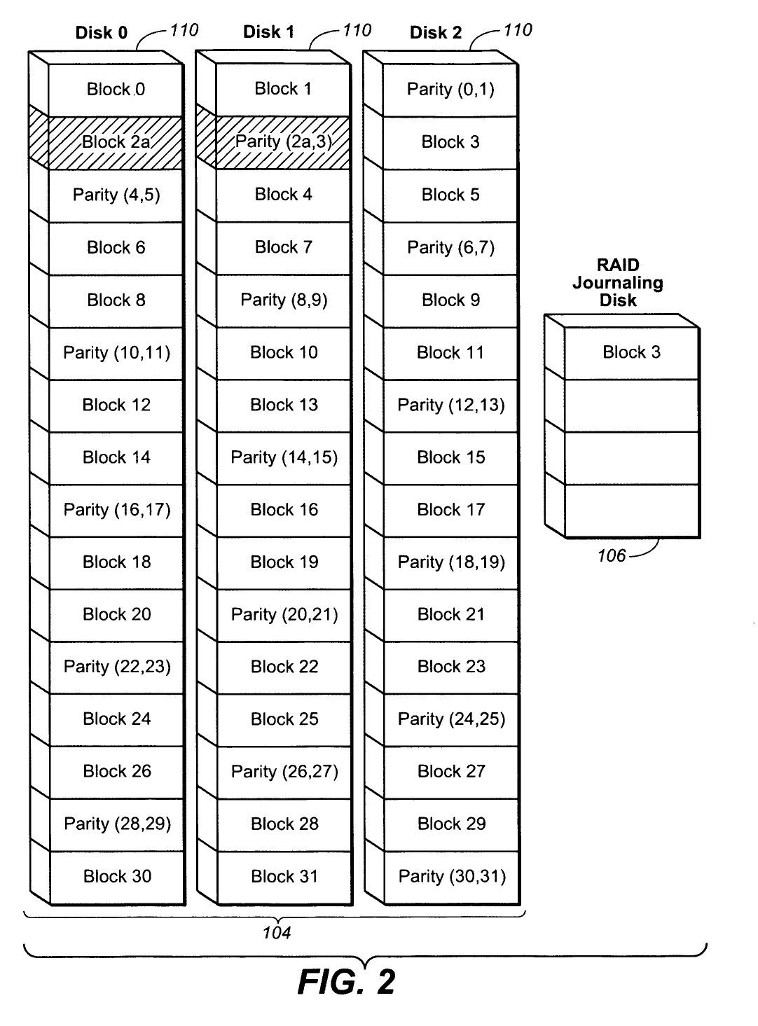

In one embodiment, illustrated in FIG. 2, a journaling disk 106 may store persistent data in the case of a power failure. FIG. 2 illustrates a RAID 5 subsequent to a power failure during which BLOCK 2a and PARITY (2a, 3) were being written. In this embodiment, the RAID 5 system would ensure that BLOCK 3, which is generated using older BLOCK 2 and PARITY (2, 3), would be stored persistently on the journaling disk. Persistently stored data may include data stored in non-volatile storage such that the data is retained between program executions. Subsequent to a power failure condition and system rebooting, a RAID 5 system would fix the parity by using the persistent data stored on the journaling disk 106 and the data on BLOCK 2a, even if BLOCK 2a was not written completely during system power failure. Similar concepts may be applied to RAID 3, RAID 4, and/or RAID 6 configurations to make those resilient to power failure conditions.

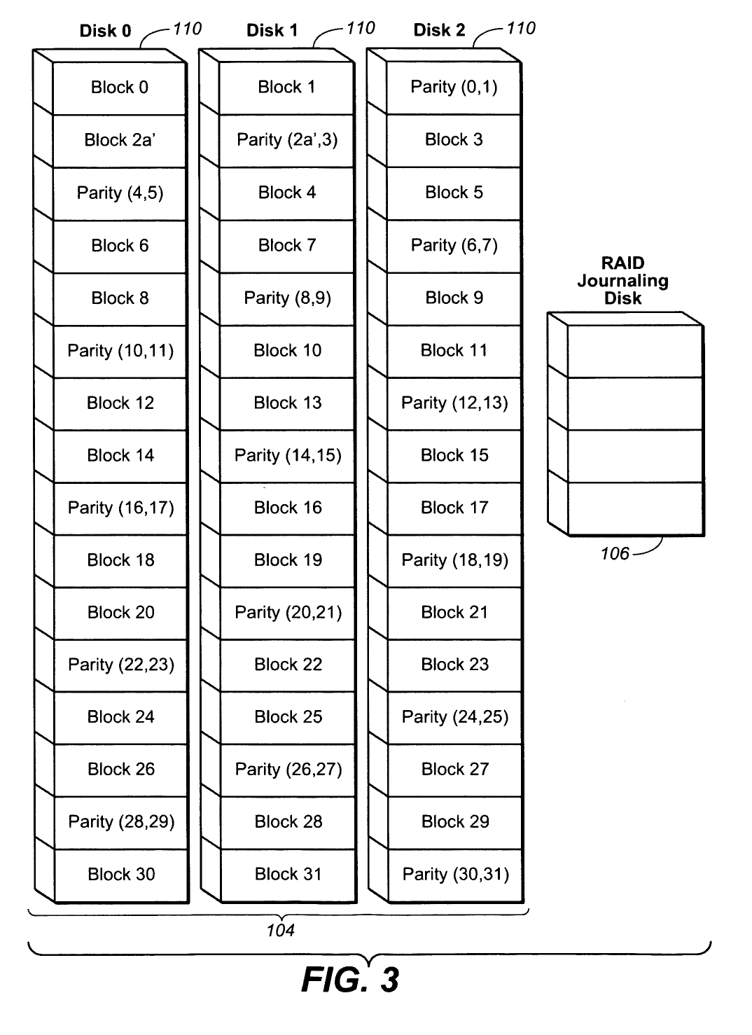

FIG. 3 illustrates the final RAID 5 configuration after recovery from the system power failure condition shown in FIG. 2. BLOCK 2a′ represents an incomplete WRITE because of power failure. Data on BLOCK 3 may be available by executing an XOR operation. An example XOR operation may include the following:
BLOCK N XOR BLOCK N+1=PARITY (N, N+1), and therefore
BLOCK N=PARITY (N, N+1) XOR BLOCK N+1, or
BLOCK N+1=PARITY (N, N+1) XOR BLOCK N.
   An XOR operation may include an exclusive disjunction, or a logical disjunction on two operands that produces a value of true only in cases where the truth value of the operands is different. The above XOR operations may ensure that in event of any one drive failure for a RAID 5 configuration, the missing drive data may be generated using the remaining disk drives.

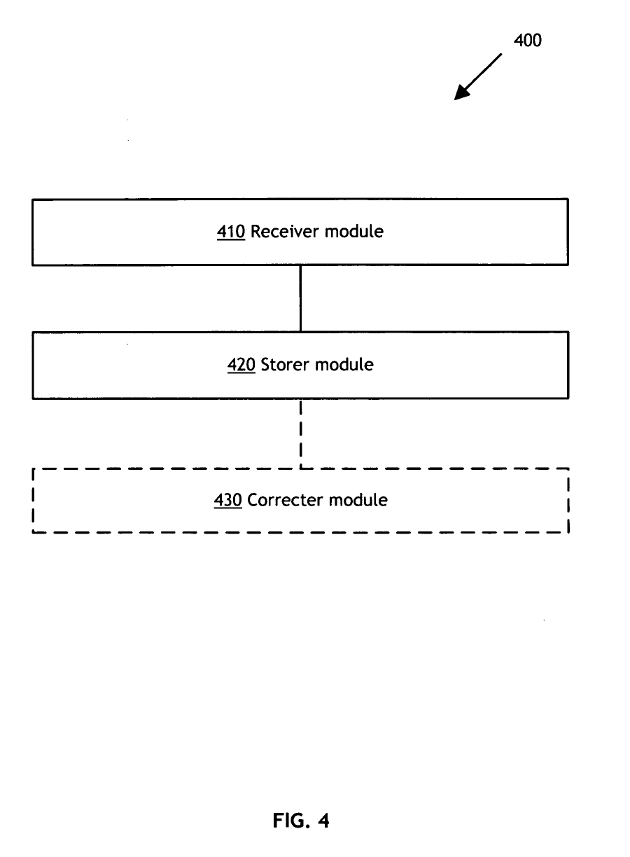

Referring to FIG. 4, a system 400 for receiving at least one of a read command or a write command, storing information on an array of disk drives at least partially based on receiving the at least one of a read command or a write command and/or storing persistent information on a journaling drive is illustrated. The system 400 may include receiver module 410, storer module 420, and/or correcter module 430. System 400 generally represents instrumentality for receiving at least one of a read command or a write command, storing information on an array of disk drives at least partially based on receiving the at least one of a read command or a write command and/or storing persistent information on a journaling drive. The steps of receiving at least one of a read command or a write command, storing information on an array of disk drives at least partially based on receiving the at least one of a read command or a write command and/or storing persistent information on a journaling drive may be accomplished electronically (e.g. with a set of interconnected electrical components, an integrated circuit, and/or a computer processor, etc.) and/or mechanically (e.g. an assembly line, a robotic arm, etc.).

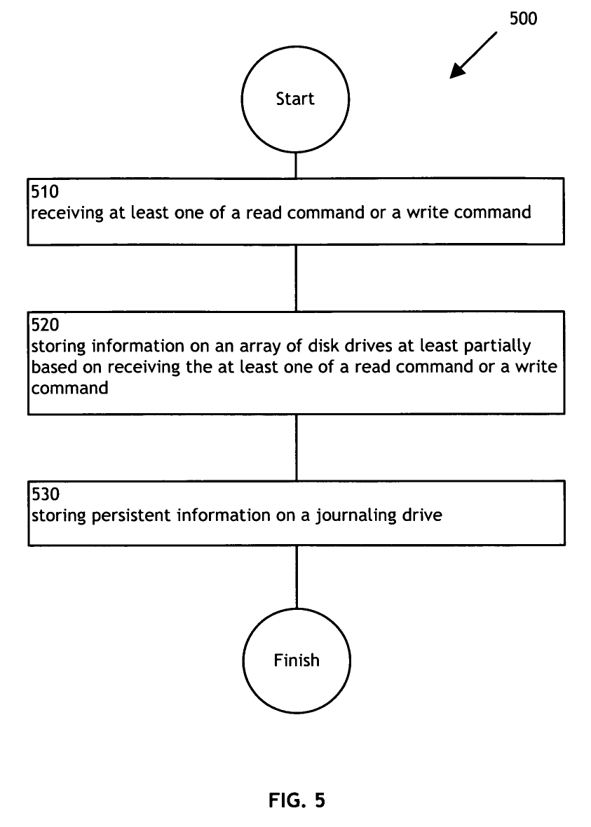

Referring to FIG. 5, a method for receiving at least one of a read command or a write command, storing information on an array of disk drives at least partially based on receiving the at least one of a read command or a write command and/or storing persistent information on a journaling drive is disclosed. FIG. 5 illustrates an operational flow 500 representing example operations related to receiving at least one of a read command or a write command, storing information on an array of disk drives at least partially based on receiving the at least one of a read command or a write command and/or storing persistent information on a journaling drive. In FIG. 5 and in following figures that include various examples of operational flows, discussion and explanation may be provided with respect to the above-described examples of FIGS. 1 through 4, and/or with respect to other examples and contexts. However, it should be understood that the operational flows may be executed in a number of other environments and contexts, and/or in modified versions of FIGS. 1 through 7. Also, although the various operational flows are presented in the sequence(s) illustrated, it should be understood that the various operations may be performed in other orders than those which are illustrated, or may be performed concurrently.

After a start operation, the operational flow 500 moves to a receiving operation 510, where receiving at least one of a read command or a write command may occur. For example, as generally shown in FIGS. 1 through 4, receiver module 410 may receive at least one of a read command or a write command. In one embodiment, receiver module 410 may receive a write command from host server 102. In some instances, receiver module 410 may include a computer processor, computer memory, and/or a computer controller.

Then, in a storing operation 520, storing information on an array of disk drives at least partially based on receiving the at least one of a read command or a write command may occur. For example, as shown in FIGS. 1 through 4, storer module 420 may store information on an array of disk drives at least partially based on receiving the at least one of a read command or a write command. In one embodiment, storer module 420 may store information on a RAID 5 based on receiving at least one of a read command or a write command. In some instances, storer module 420 may include a computer processor and/or computer memory.

Then, in a storing operation 530, storing persistent information on a journaling drive may occur. For example, as shown in FIGS. 1 through 4, storer module 420 may store persistent information on a journaling drive. In one embodiment, storer module 420 may store persistent information on a journaling drive communicably coupled to a RAID 5 system and RAID controller 108. In some instances, storer module 420 may include a computer processor and/or computer memory.

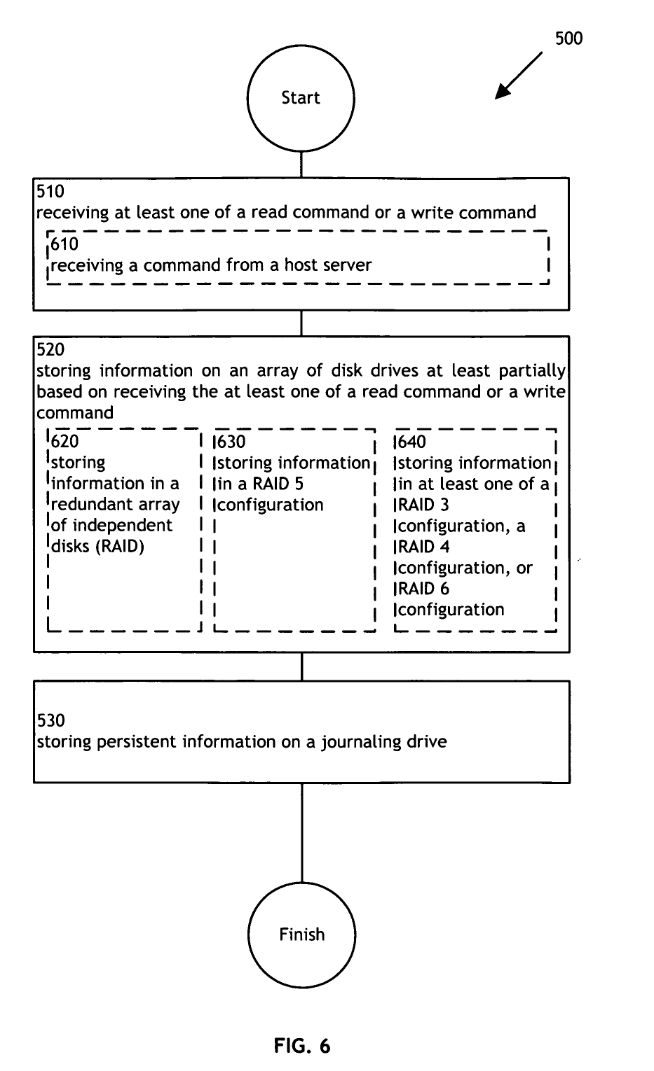

FIG. 6 illustrates alternative embodiments of the example operational flow 500 of FIG. 5. FIG. 6 illustrates example embodiments where receiving operation 510, storing operation 520, and/or storing operation 530 may include at least one additional operation. Additional operations may include an operation 610, operation 620, operation 630, and/or operation 640.

At operation 610, receiving a command from a host server may occur. For example, receiver module 410 may receive a command from a host server. In one embodiment, receiver module 410 may receive a command from a host server to write data to a hard drive in a RAID configuration. In some instances, receiver module 410 may include a computer processor, computer memory, and/or a computer controller.

At operation 620, storing information in a redundant array of independent disks (RAID) may occur. For example, storer module 420 may store information in a redundant array of independent disks (RAID). In one embodiment, storer module 420 may store information in a RAID configuration. In some instances, storer module 420 may include a computer processor, a RAID controller, and/or computer memory.

At operation 630, storing information in a RAID 5 configuration may occur. For example, storer module 420 may store information in a RAID 5 configuration. In one embodiment, storer module 420 may store information in a RAID 5 configuration. In some instances, storer module 420 may include a computer processor, a RAID controller, and/or computer memory.

At operation 640, storing information in at Least one of a RAID 3 configuration, a RAID 4 configuration, or RAID 6 configuration may occur. For example, storer module 420 may store information in a RAID 3 configuration, a RAID 4 configuration, or RAID 6 configuration. In one embodiment, storer module 420 may store information in a RAID 6 configuration. In some instances, storer module 420 may include a computer processor, a RAID controller, and/or computer memory.

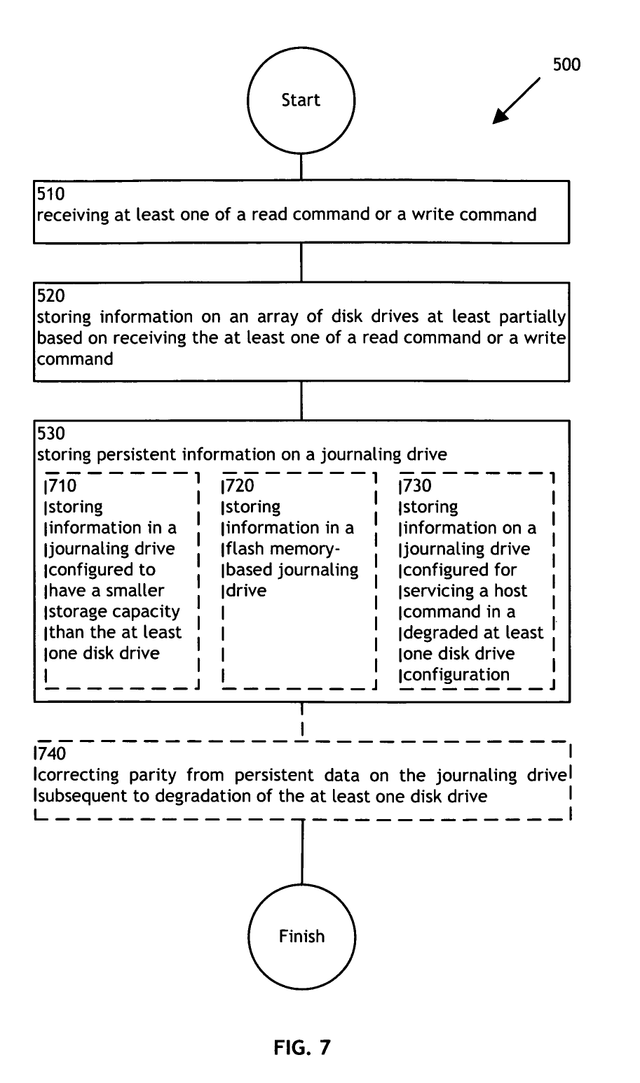

FIG. 7 illustrates alternative embodiments of the example operational flow 500 of FIG. 5. FIG. 7 illustrates example embodiments where receiving operation 510, storing operation 520, and/or storing operation 530 may include at least one additional operation. Additional operations may include an operation 710, operation 720, operation 730, and/or operation 740.

At operation 710, storing information in a journaling drive configured to have a smaller storage capacity than the at least one disk drive may occur. For example, storer module 420 may store information in a journaling drive configured to have a smaller storage capacity than the at least one disk drive. In one embodiment, storer module 420 may store information in a journaling drive with a much smaller storage capacity than a RAID configuration. In this embodiment, the journaling disk may, for example, have a 5 gigabyte storage capacity while the RAID configuration may have a one terabyte storage capacity. In some instances, storer module 420 may include a computer processor, a RAID controller, and/or computer memory.

At operation 720, storing information in a flash memory-based journaling drive may occur. For example, storer module 420 may store information in a flash memory-based journaling drive. In one embodiment, storer module 420 may store information in a flash memory-based journating drive. Flash-based memory may include non-volatile computer memory that can be electrically erased and reprogrammed. In some instances, storer module 420 may include a computer processor, a RAID controller, and/or computer memory.

At operation 730, storing information on a journating drive configured for servicing a host command in a degraded at least one disk drive configuration may occur. For example, storer module 420 may store information on a journaling drive configured for servicing a host command in a degraded at least one disk drive configuration. In one embodiment, storer module 420 may store information on a journating drive that services a host command in a degraded RAID configuration. In some instances, storer module 420 may include a computer processor, a RAID controller, and/or computer memory.

At operation 740, correcting parity from persistent data on the journating drive subsequent to degradation of the at least one disk drive may occur. For example, correcter module 430 may correct parity from persistent data on the journating drive subsequent to degradation of the at least one disk drive. In one embodiment, correcter module 430 may correct parity from persistent data on the journaling drive after a RAID system experiences a power failure during a write operation. In some instances, correcter module 430 may include a computer processor and/or a RAID controller.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A system for storing data, comprising:
a disk array including a plurality of disk drives;
a journaling disk; and
a RAID controller communicatively coupled to the journaling disk and the disk array, and configured for reading from the disk array and writing to the disk array at least partially based upon commands received from the host server.

2. The system of claim 1, wherein the disk array including a plurality of disk drives comprises:
a redundant array of independent disks configuration (RAID).

3. The system of claim 1, wherein the RAID controller comprises:
a controller configured for storing uncommitted writes to the journaling disk.

4. The system of claim 1, wherein the disk array including a plurality of disk drives comprises:
a RAID 5 configuration.

5. The system of claim 1, wherein the disk array including a plurality of disk drives comprises:
at least one of a RAID 3 configuration, a RAID 4 configuration, or a RAID 6 configuration.

6. The system of claim 1, wherein the journaling disk comprises:
a supplemental disk to the disk array configured for receiving metadata.

7. The system of claim 1, wherein the journating disk comprises:
a journating disk configured to be sized according to a ratio number of outstanding WRITE commands versus the size of a RAID volume.

8. The system of claim 1, wherein the journaling disk comprises:
a journaling disk configured to service the host write command in a degraded RAID configuration.

9. The system of claim 1, wherein the journaling disk comprises:
a journaling disk configured to have a smaller volume than the disk array including a plurality of disk drives.

10. The system of claim 1, further comprising:
a host server.

11. A method, comprising:
receiving at least one of a read command or a write command;
storing information on an array of disk drives at least partially based on receiving the at least one of a read command or a write command; and
storing persistent information on a journating drive.

12. The method of claim 11, wherein receiving at least one of a read command or a write command comprises:
receiving a command from a host server.

13. The method of claim 11, wherein storing information on an array of disk drives at least partially based on receiving the at least one of a read command or a write command comprises:
storing information in a redundant array of independent disks (RAID).

14. The method of claim 13, wherein storing information in a redundant array of independent disks (RAID) comprises:
storing information in a RAID 5 configuration.

15. The method of claim 13, wherein storing information in a redundant array of independent disks (RAID) comprises:
storing information in at least one of a RAID 3 configuration, a RAID 4 configuration, or RAID 6 configuration.

16. The method of claim 11, wherein storing persistent information on a journaling drive comprises:
storing information in a journaling drive configured to have a smaller storage capacity than the at least one disk drive.

17. The method of claim 11, wherein storing persistent information on a journaling drive comprises:
storing information in a flash memory-based journaling drive.

18. The method of claim 11, wherein storing persistent information on a journaling drive comprises:
storing information on a journaling drive configured for servicing a host command in a degraded at least one disk drive configuration.

19. The method of claim 11, further comprising:
correcting parity from persistent data on the journaling drive subsequent to degradation of the at least one disk drive.

20. A RAID system for storing data, comprising:
a RAID 5 disk array including at Least two disk drives;
a journaling disk communicatively coupled to the RAID 5 disk array, where the journating disk is a solid state drive configured to store persistent data and has a smaller storage volume than the RAID 5 disk array; and
a RAID controller communicatively coupled to the journaling disk and the RAID 5 disk array, where the RAID controller is configured for reading from the RAID 5 disk array and writing to the RAID 5 disk array at least partially based upon commands received from a host server.
